(19) United States
(12) Patent Application Publication
(10) Pub. No.: US 2026/0218608 A1
(43) Pub. Date: Jul. 30, 2026

(54) SYSTEMS AND METHODS FOR COMMUNICATION WITH BOTTOM-HOLE ASSEMBLIES

(71) Applicant: TAQA DRILLING SOLUTIONS, INC., Edmonton (CA)

(72) Inventor: Daniel SULLIVAN, Edmonton (CA)

(21) Appl. No.: 19/159,038

(22) PCT Filed: Feb. 26, 2024
(86) PCT No.: PCT/CA2024/050226

§ 371 Date: Aug. 22, 2025

Related U.S. Application Data
(60) Provisional application No. 63/448,000, filed on Feb. 24, 2023.

(51) Int. Cl. E21B 47/20; E21B 7/06; E21B 21/08

(52) U.S. Cl. CPC E21B 47/20; E21B 7/06; E21B 21/08

(57) ABSTRACT

Embodiments here generally relates to methods and systems for communication with bottom-hole assemblies. In at least one embodiment, the systems comprises: a control system comprising at least one processor configured for: identifying a command ratio value (CRV) associated with at least one command; based on the CRV, determining a command time (CT) and a command divisor time (CDT) for encoding the at least one command into a command signal; transmitting the command signal by controlling modulation of drilling fluid flow properties and generating a modulated fluid flow, wherein the modulated fluid flow: (i) extends for a duration of time equal to the CT, and (ii) varies between at least a base flow state and a modified flow state, the modified flow state extending for the command divisor time (CDT).

### CROSS-RELATED APPLICATIONS

The present application claims the priority benefit of U.S. Provisional Application 63/448,000, filed on Feb. 24, 2023, the entire contents of which are incorporated herein by reference.

### FIELD

Various embodiments are described herein that generally relate to drilling systems and bottom-hole assemblies, and in particular, to methods and systems for communication with bottom-hole assemblies.

### BACKGROUND

Hydrocarbons and other deposits, located in subsurface formations, are typically extracted by drilling wellbores into these formations. In many cases, the wellbores are drilled using a bottom-hole assembly (BHA) comprising a rotating drill bit. The BHA, itself, is coupled to a rotating drill string that extends downwardly, from an over surface drill rig, into the subsurface formation. To that end, modern BHAs are now typically designed for directional drilling. This enables drilling wellbores with controlled directional changes, i.e., as opposed to a simple vertical drill. One example of directional drilling technology includes rotatory steerable systems (RSS).

### SUMMARY OF VARIOUS EMBODIMENTS

In at least one broad aspect, there is provided a system for downlink communication with a bottom-hole assembly (BHA), comprising: a control system comprising at least one processor configured for: identifying a command ratio value (CRV) associated with at least one command; based on the CRV, determining a command time (CT) and a command divisor time (CDT) for encoding the at least one command into a command signal; transmitting the command signal by controlling modulation of drilling fluid flow properties and generating a modulated fluid flow, wherein the modulated fluid flow: (i) extends for a duration of time equal to the CT, and (ii) varies between at least a base flow state and a modified flow state, the modified flow state extending for the command divisor time (CDT); and the bottom-hole assembly (BHA) comprising at least one controller configured for: detecting the modulated fluid flow corresponding to the command signal; analyzing the modulated fluid flow to determine the command time (CT) and the command divisor time (CDT); determining the CRV based on the analyzed CT and DT; and decoding the at least one command based on the CRV.

In some embodiments, the at least one controller of the BHA is further configured for: operating the assembly to execute the at least one command.

In some embodiments, the at least one command relates to adjusting a tool operating mode.

In some embodiments, the at least one command relates to selecting a steering reference field.

In some embodiments, the at least one command relates to adjusting a steering target.

In some embodiments, determining the CRV by the at least one processor, of the control system, comprises: accessing pre-defined assignment data comprising associations between commands and corresponding CRVs.

In some embodiments, the pre-defined assignment data is in the form of a reference look-up table.

In some embodiments, the assignment data comprises associations between commands and command identifiers, the command identifiers being generated from the CRV.

In some embodiments, the assignment data is stored on a memory database of the control system, the memory being coupled to the at least one processor.

In some embodiments, the drilling system further comprises at least one pump for pumping drilling fluid to the BHA, and controlling modulation of fluid properties comprises controlling the at least one pump.

In some embodiments, drilling system further comprises at least one flow diverter, and controlling modulation of fluid properties comprises controlling the at least one flow diverter.

In some embodiments, the fluid properties comprise the fluid flow rate and/or fluid pressure.

In some embodiments, in the modified flow state, the drilling fluid has fluid flow properties that is one of greater or less than the base flow state.

In some embodiments, the modulated fluid flow varies between three flow states corresponding to: (i) the base flow state; (ii) an intermediate flow state; and (iii) the modified flow state.

In some embodiments, the intermediate flow state has flow properties that are between the base and modified flow states.

In some embodiments, modulating the fluid flow properties to transmit the command signal comprises controlling modulation of the fluid flow properties to: initially, generate a trigger signature portion; subsequently, generate a modified flow portion wherein the fluid properties are maintained at the modified flow state for the command divisor time (CDT); and generate a return flow portion, wherein the fluid flow properties are returned to the base flow state.

In some embodiments, the trigger signature portion comprises: (a) a first transition from the base state to the intermediate state; (b) a plateau at the intermediate state; and (c) a second transition from the plateau to the modified state. In some embodiments, the CRV is related to the command time (CT) and command divisor time (CDT) as expressed by the equation:

$$Command Ratio Value ( CRV ) = CT / CDT \times CT$$

In some embodiments, the CT and CDT are expressed in configurable bit time units.

In some embodiments, after transmitting the command signal, the at least one processor, of the control system, is further configured for: transmitting a data payload signal, associated with the command signal, by further controlling modulation of the drilling fluid flow properties.

In some embodiments, the data payload signal is transmitted within a data gate time interval of the end of the command signal.

In some embodiments, the at least one controller of the BHA detects the modulated fluid flow, corresponding to the command signal, by detecting the trigger signature.

In some embodiments, a memory of the BHA stores an expected flow configuration for the trigger signature, and detecting the trigger signature comprises: comparing the modulated fluid flow configuration to the expected configuration.

In some embodiments, the BHA further comprises a sensor system coupled to the at least one controller, and detecting the modulated fluid flow is based on sensor data generated by the sensor system.

In some embodiments, the sensor system comprises at least one of: (i) a flow rate sensor; (ii) a pressure transducer; and (iii) a sensor for monitoring rotational rate of a motor inside the BHA.

In some embodiments, analyzing the modulated fluid flow, by the at least one controller of the BHA, to determine the command time (CT) and command divisor time (CDT) comprises: determining the command time (CT) based on determining a start time and end time for the CT; and determining the command divisor time (CDT) based on determining a start time and end time for the CDT.

In some embodiments, the at least one controller of the BHA is further configured for: subsequent to detecting a first modulated fluid flow corresponding to the command signal, detecting a second modulated fluid flow corresponding to a data payload signal; and operating the assembly to execute the at least one command and command parameters decoded from the data payload signal.

In some embodiments, the data payload signal is received within a data gate time interval of the command signal.

In some embodiments, decoding the at least one command by the at least one controller of the BHA is based on accessing the pre-defined assignment data comprising associations between commands and corresponding CRVs.

In some embodiments, the pre-defined assignment data is stored on a memory database of the BHA, coupled to the at least one controller.

In some embodiments, the at least one processor, of the control system, is further configured for: determining transmission properties of different commands; identifying one or more downlink optimization criteria; and updating the assignment data based on the transmission properties and the downlink optimization criteria.

In some embodiments, the at least one processor, of the control system, is further configured for: determining an operation mode; selecting an assignment dataset, of one or more assignment datasets, association with the operation mode; and transmitting command signals using the selected assignment dataset.

In another broad aspect, there is provided a method for downlink communication with a bottom-hole assembly (BHA), comprising: identifying, by at least one processor of a control system, a command ratio value (CRV) associated with at least one command; based on the CRV, determining, by the at least one processor, a command time (CT) and a command divisor time (CDT) for encoding the at least one command into a command signal; transmitting, by the at least one processor, the command signal by controlling modulation of drilling fluid flow properties and generating a modulated fluid flow, wherein the modulated fluid flow: (i) extends for a duration of time equal to the CT, and (ii) varies between at least a base flow state and a modified flow state, the modified flow state extending for the command divisor time (CDT); detecting, by at least one controller of the bottom-hole assembly (BHA), the modulated fluid flow corresponding to the command signal; analyzing, by the at least one controller, the modulated fluid flow to determine the command time (CT) and the command divisor time (CDT); determining, by the at least one controller, the CRV based on the analyzed CT and DT; and decoding, by at least one controller, the at least one command based on the CRV.

In another broad aspect, there is provided a control system for use in downlink communication with a bottom-hole assembly (BHA), comprising at least one processor configured for: identify a command ratio value (CRV) associated with at least one command; based on the CRV, determine a command time (CT) and a command divisor time (CDT) for encoding the at least one command into a command signal; transmit the command signal by controlling modulation of drilling fluid flow properties and generating a modulated fluid flow, wherein the modulated fluid flow: (i) extends for a duration of time equal to the CT, and (ii) varies between at least a base flow state and a modified flow state, the modified flow state extending for the command divisor time (CDT).

In another broad aspect, there is provided a method for downlink communication comprising: identifying, by at least one processor of a control system, a command ratio value (CRV) associated with at least one command; based on the CRV, determining, by the at least one processor, a command time (CT) and a command divisor time (CDT) for encoding the at least one command into a command signal; transmitting, by the at least one processor, the command signal by controlling modulation of drilling fluid flow properties and generating a modulated fluid flow, wherein the modulated fluid flow: (i) extends for a duration of time equal to the CT, and (ii) varies between at least a base flow state and a modified flow state, the modified flow state extending for the command divisor time (CDT).

In another broad aspect, there is provided a bottom-hole assembly (BHA) comprising at least one controller configured for: detecting the modulated fluid flow corresponding to the command signal, wherein the modulated fluid flow: (i) extends for a duration of time equal to a command time (CT), and (ii) varies between at least a base flow state and a modified flow state, the modified flow state extending for a command divisor time (CDT); analyzing the modulated fluid flow to determine the command time (CT) and the command divisor time (CDT); determining a command ratio value (CRV) based on the analyzed CT and CDT; and decoding for at least one command based on the CRV.

In another broad aspect, there is provided a method for downlink communication comprising: detecting, by at least one controller of the bottom-hole assembly (BHA), a modulated fluid flow corresponding to the command signal, wherein the modulated fluid flow: (i) extends for a duration of time equal to a command time (CT), and (ii) varies between at least a base flow state and a modified flow state, the modified flow state extending for a command divisor time (CDT); analyzing, by the at least one controller, the modulated fluid flow to determine a command time (CT) and the command divisor time (CDT); determining, by the at least one controller, a command ratio value (CRV) based on the analyzed CT and CDT; and decoding, by at least one controller, for at least one command based on the CRV.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is a simplified schematic illustration of an example drilling system incorporating directional drilling technology.

FIG. 2A is a plot of an example Manchester encoding method used for downlink communication.

FIG. 2B is a plot of an example pulse position encoding method used for downlink communication.

FIG. 3A is a plot showing a downlink signal comprising one or more command signals generated in accordance with embodiments described herein.

FIG. 3B is a plot of an example command signal.

FIG. 3C is another plot showing a downlink signal comprising one or more command signals, generated in accordance with embodiments described herein.

FIG. 3D is a plot of an example command signal, according to another embodiment.

FIG. 3E is a plot of an example command signal, according to still another embodiment.

FIG. 3F is a plot of an example command signal, according to still yet another embodiment.

FIG. 4 are plots showing different example command signals generated in accordance with embodiments described herein.

FIG. 5 is a plot showing a downlink signal comprising a command signal followed by an associated data payload signal.

FIG. 6 is an example method for downlink communication in a drilling system.

FIG. 7A is an example method for operating a control system for downlink communication.

FIG. 7B is an example method for operating a bottom-hole assembly (BHA) for downlink communication.

FIG. 7C is another example method for operating a bottom-hole assembly (BHA) for downlink communication.

FIG. 8A is an example method for configuring assignment data during downlink communication.

FIG. 8B is an example method for selecting between one or more assignment datasets during downlink communication.

FIG. 9A is a simplified block diagram of an example hardware configuration for a drilling control system.

FIG. 9B is a simplified block diagram of an example hardware configuration for a bottom-hole assembly (BHA).

Further aspects and features of the example embodiments described herein will appear from the following description taken together with the accompanying drawings.

### DESCRIPTION OF VARIOUS EMBODIMENTS

Embodiments disclosed herein generally relate to methods and systems for communication with bottom-hole assemblies (BHAs), used in drilling systems. In at least one embodiment, the disclosed methods and systems are applied to directional drilling systems. For example, the methods and systems are used for controlling different operating features of a BHA adapted for directional drilling, e.g., adjusting tool face, steering ratio, etc. More generally, however, the disclosed methods and systems can be applied to any drilling system in which the BHA includes any controllable feature.

### I. DEFINITIONS

Any term or expression not expressly defined herein shall have its commonly accepted definition understood by a person skilled in the art. As used herein, the following terms have the following meanings.

“Downlink communication” refers broadly to any communication path (e.g., communication channel) used to transmit data and/or other information to a bottom-hole assembly (BHA), in a drilling system. For example, this can include transmitting control data from a surface control system, or terminal, to the BHA.

“Up-link communication” refers broadly to any communication path (e.g., channel) used for transmitting data, and/or other information, from a bottom-hole assembly (BHA). For example, this can include transmitting data, e.g., sensor data, from the BHA to an above-surface control system or terminal.

“Controllable drilling system” is a drilling system in which any and/or all portions of the system are controllable, or otherwise configurable. For example, this can include a drilling system in which operation of the bottom-hole assembly (BHA) is partially or fully controllable or configurable.

“Rotary steerable system (RSS)” is a form of drilling technology used for directional drilling of wellbores, as is generally known in the art.

“Processor” refers to one or more electronic devices that is/are capable of reading and executing instructions stored on a memory to perform operations on data, which may be stored on a memory or provided in a data signal. The term “processor” includes a plurality of physically discrete, operatively connected devices despite use of the term in the singular. Non-limiting examples of processors include devices referred to as microprocessors, microcontrollers, central processing units (CPU), and digital signal processors.

“Memory” refers to a non-transitory tangible computer-readable medium for storing information in a format readable by a processor, and/or instructions readable by a processor to implement an algorithm. The term “memory” includes a plurality of physically discrete, operatively connected devices despite use of the term in the singular. Non-limiting types of memory include solid-state, optical, and magnetic computer readable media. Memory may be non-volatile or volatile. Instructions stored by a memory may be based on a plurality of programming languages known in the art, with non-limiting examples including the C, C++, Python™, MATLAB™, and Java™ programming languages.

### II. EXAMPLE OPERATING ENVIRONMENT

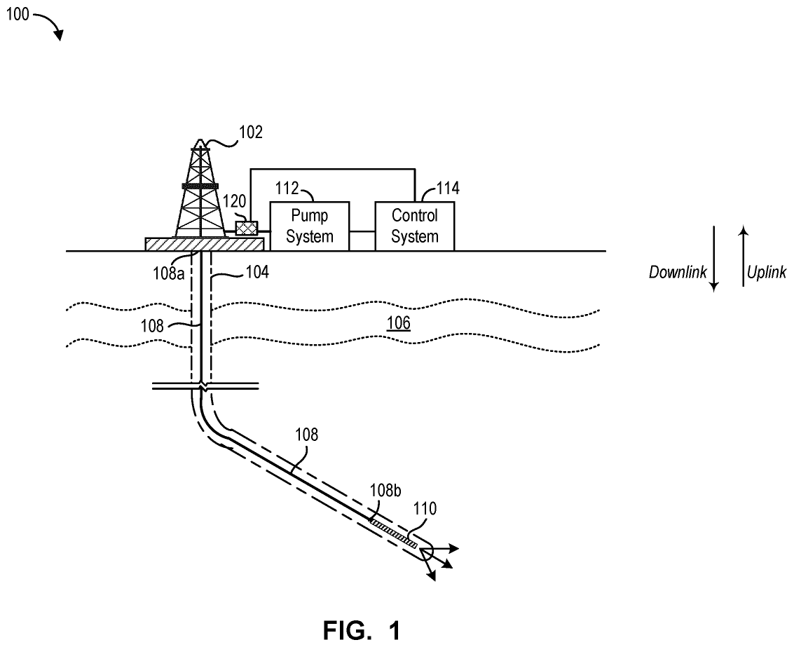

Reference is now made to FIG. 1, which is a schematic illustration of an example controllable drilling system (100) (also referenced herein throughout as drilling system (100)). Drilling system (100) exemplifies an operating environment for applying the methods and systems described herein.

As shown, drilling system (100) includes a drilling rig (102) for drilling a wellbore (104) into a subsurface formation (106). Formation (106) can include various extractable hydrocarbon deposits.

To drill wellbore (104), drilling rig (102) is connected to a bottom-hole assembly (BHA) (110). The connection, between the drilling rig (102) and the BHA (110), occurs via a rotating drill string (108). More generally, drill string (108) couples to the drill rig (102) at a first, upper-end (108a), and couples to the BHA (110) at a distal, second lower-end (108b).

In some cases, the upper end (108a)—of drill string (108)—attaches to a rotating system, located within the drill rig (102) (not shown). The rotating system causes rotation of the drill string (108) in order to facilitate drilling operations. The rotating system can comprise, for example, a top drive system or a Kelly drive.

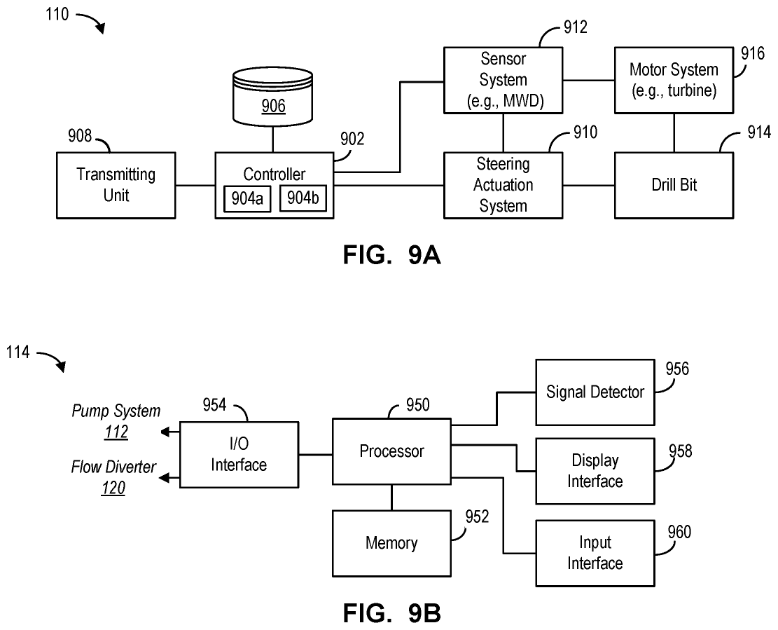

As previously noted, BHA (110) is primarily responsible for drilling into the formation (106). As clarified in greater detail, with reference to FIG. 9A, BHA (110) can generally include a rotating drill bit (914). BHA (110) can also include a sensor system (912) for acquiring sensor data. The sensor data can correspond to directional and/or formation-based measurements. Among other functions, the sensor data assists in correctly guiding the BHA (110) to follow a desired well path trajectory.

BHA (110) can also include a controller (902) and a transmitting unit (908). Controller (902) controls operation of the various system components. Transmitting unit (908) transmits acquired sensor data to an above-surface control system (114).

In some examples, BHA (110) is adapted for directional drilling. For instance, BHA (110) can comprise a rotary steerable system (RSS). The RSS can be a point-the-bit or push-the-bit type system, and can include respective actuators and other necessary hardware. To that end, as shown in FIG. 9A, BHA (110) can include a steering actuation system (910), for controlling directional steering.

Continuing reference with FIG. 1, drilling system (100) may also include: (i) a pump system (112), (ii) flow diverter (120), and/or (ii) a surface control system (114).

Pump system (112) pumps drilling fluid through the drill string (108). The drilling fluid has several purposes, as is well known in the art, including lubricating the BHA's drill bit (914) during drilling operation and removing drill cuttings.

Drilling fluid, conveyed to the BHA (110), is typically ejected out of an opening of the drill bit (914). Ejected fluid circulates back upwardly to the surface through the annular gap defining the wellbore (104). In flowing upwardly, the ejected fluid may transport drill chips and other extraneous material out of the well bore (104).

Flow diverter (120) can be interposed between the pump system (112) and any portion of the drill string (108). Diverter (120) is used to adjust the volume of drilling fluid pumped through drill string (108).

Turning now to control system (114)—control system (114) provides control functionality to drilling system (100). By way of example, in directional drilling systems, control system (114) can control the operation mode, steering direction, as well as the selected steering reference field for BHA (110). In this manner, control system (114) exerts control over the trajectory path of well bore (104).

In the exemplified case, control system (114) is an above-surface terminal (e.g., computer terminal), which is operator manned. In other cases, however, it is not necessary for control system (114) to be above-surface. Further, control system (114) may be fully or partially-automated, or be controlled remotely through signals transmitted to the control system (114) by a remote operator.

With brief reference in FIG. 9B, control system (114) can generally include a processor (950) coupled to a memory (952). Processor (950) can also couple to input/output (I/O) interface (954), which itself couples to control one or more of the pump system (112) and/or flow diverter (120). In some examples, the control system (114) includes a display interface (958) for displaying various raw and/or processed sensor data to a system operator. An input interface (960) may also allow the operator to input commands, to be transmitted to the BHA (110) (e.g., steering commands).

### III. DOWNLINK COMMUNICATION WITH A BOTTOM-HOLE ASSEMBLY (BHA)

In FIG. 1, downlink communication is used to transmit signals from the control system (114) to the BHA (110). Downlink signals can encode commands to configure operation of the BHA (110). For example, these include commands to vary an operating mode, steering reference field and/or directional target of BHA (110). BHA (110) receives the downlink communication, and adjusts its operation accordingly.

A common challenge faced during downlink communication is resolving how to effect such communication in a reliable, efficient and timely manner. In many cases, wired communication is not a viable option to transmit downlink data. This is owing to the inability of fragile wires to withstand high-pressure and/or high temperature subsurface environments. For this reason, most downlink communication now occurs through wireless means.

Example wireless methods include using fluid pulse telemetry, electromagnetic communication and/or encoding data into the rotation rates of the drilling string (108).

To that end, a common method for wireless communication involves encoding data by varying (i.e., modulating) drilling fluid properties. Modulated fluid properties can include a modulated flow rate and/or fluid pressure. The flow rate and/or fluid pressure are varied to encode different downlink data. In this manner, the drilling fluid flow properties or parameters acts as a “carrier signal” for the transmitted data.

Using this communication technique, fluid properties are modulated (e.g., varied) using one of several methods. In one example, control system (114) directly controls the pump system (112) to vary the fluid properties. For example, control system (114) adjusts the pump stroke to increase or decrease the fluid flow rate and/or fluid pressure, as necessary.

In another example, control system (114) controls the flow diverter (e.g., a dump or bypass valve) to increase or decrease flow rate and/or pressure, also as necessary.

On the BHA (110)—side, BHA (110) includes one or more sensors for monitoring fluid properties. For example, sensor system (912) (FIG. 9A) can include flow meters and/or pressure sensors for monitoring variations in flow rate and/or fluid pressure.

In other examples, BHA (110) includes rotation sensor(s) coupled to the turbine motor (915). The rotation sensor(s) monitor the rotation speed (e.g., RPM) of the turbine, which is a proxy for the fluid flow rate and/or pressure. The detected fluid properties are demodulated to decode and resolve the transmitted command. A processor, of the BHA (110), can then execute the decoded command.

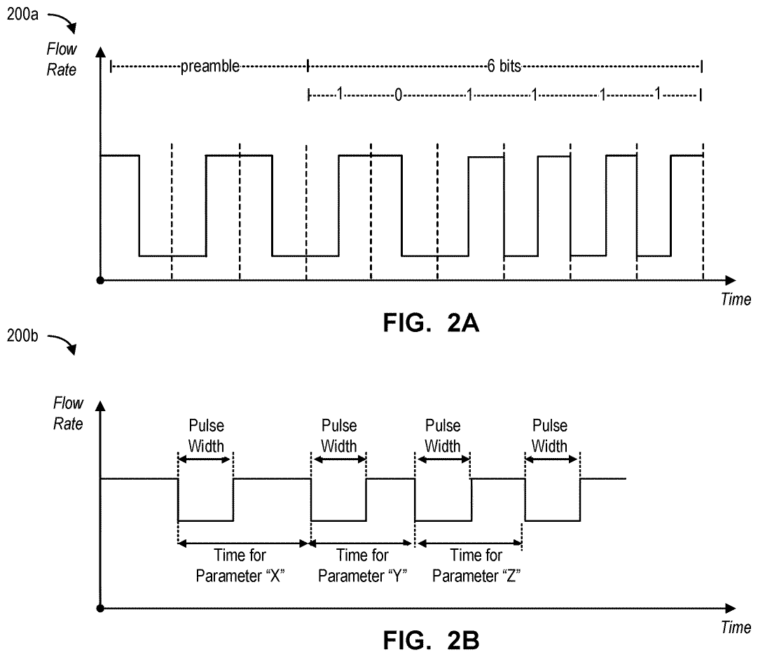

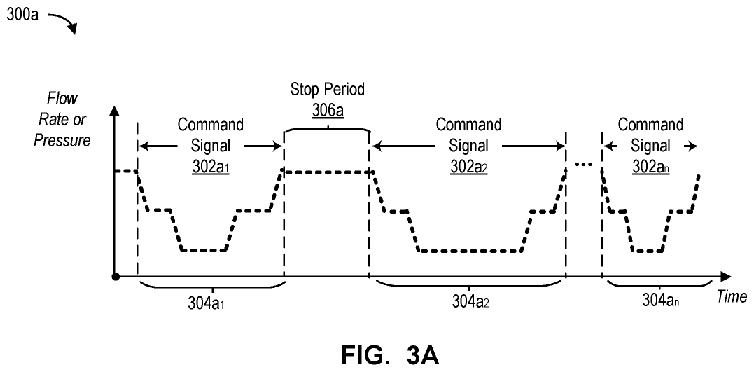

Reference is now made to FIGS. 2A and 2B, which illustrate some example methods for downlink communication using modulated fluid properties.

FIG. 2A is an example of a Manchester based modulation method. FIG. 2B is an example pulse-position modulation (PPM) method.

In the Manchester method (FIG. 2A), a data bit is encoded through a high-to-low, or low-to-high transition within a bit period. In other words, the pump transitions are timed in the middle of the bit window. Typically, the window width can be anywhere between 30, 45 and 60 seconds. Each command signal is often encoded in a six bit stream sequence, as shown in FIG. 2A. In some cases, the bit stream is also preceded by a preamble (e.g., a 3 bit preamble) and can include parity and/or CRC bits.

Manchester modulation techniques, however, suffer from a number of important drawbacks. In particular, using Manchester modulation, all command signals require an equal time duration for downlink transmission. In other words, all command signals are modulated using the same bit sequence comprising a preamble, followed by a six-bit window. In this manner, using a thirty second bit window—the nine bits in FIG. 2A will always require 4 minutes and 30 seconds to transmit (or 9 minutes, using a 60 second window).

In contrast to Manchester encoding, a pulse position modulation (PPM) method (FIG. 2B) encodes commands in the time between transmitted pulses. In some cases, a sixty second (60 second) “quiet” preamble is added before the signal. In PPM schemes, the downlink time usually varies between 7 and 15 minutes.

In view of the foregoing, there is a desire for a system and method for downlink communication which mitigates at least some of the drawbacks of existing methods.

### IV. EXAMPLE DOWNLINK COMMAND SIGNAL

The following is a description of an example configuration for a downlink command signal. The exemplified command signal is generated by modulating a flow property (e.g., flow rate and/or pressure) of a fluid pumped to the bottom-hole assembly (BHA) (110). In at least one example, the command signal is generated by modulating fluid properties between three flow states: (i) a first, base flow state; (ii) a second, intermediate flow state; and (iii) a third, modified flow state. In this manner, the disclosed methods of downlink communication are referenced herein as “tri-state” downlink communication.

As further described, different commands are encoded into command signals by varying a ratio index of: (a) a total time for transmitting the command signal; and (b) a time duration for transmitting the modified flow state. Using this ratio index to encode commands may have several appreciable advantages, which are described further below.

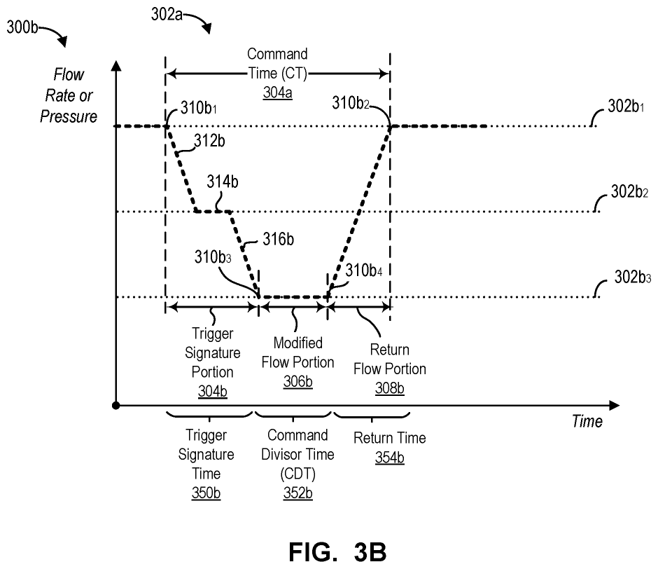

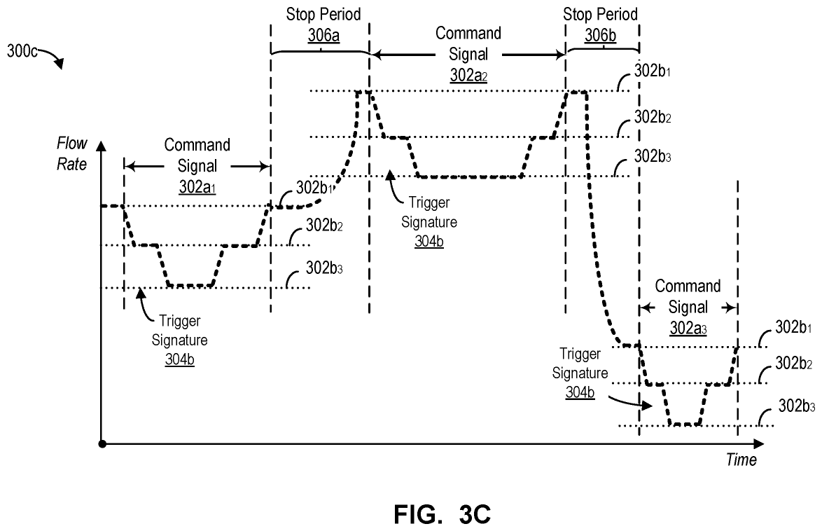

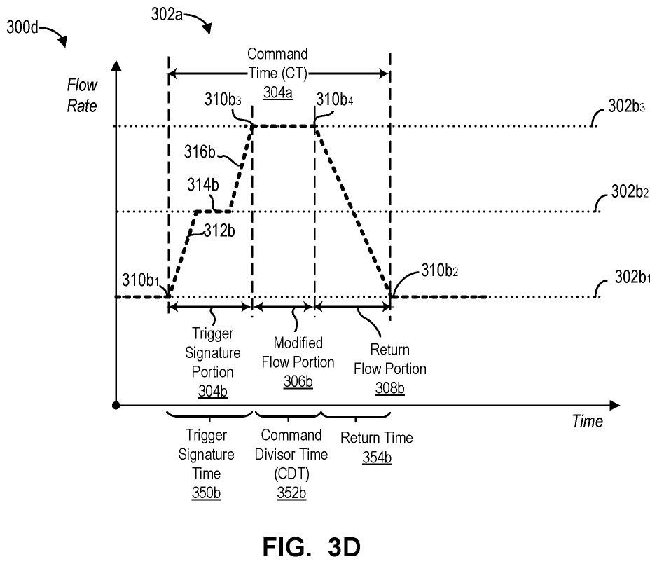

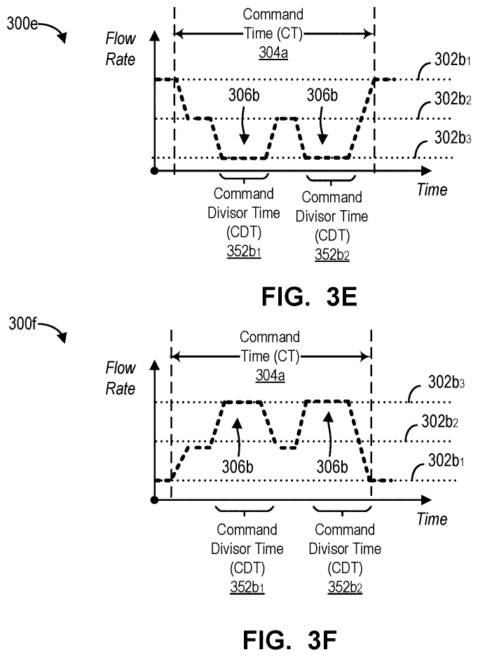

Reference is now made to FIG. 3A, which shows a plot (300a) for an example downlink signal, in accordance with embodiments herein.

The exemplified downlink signal can be generated by controlling one or both of the pump system (112) and flow diverter (120) to modulate at least one fluid property for fluid conveyed to BHA (110). The at least one modulated fluid property can be either or both of the flow rate and fluid pressure.

As shown, the downlink signal can include one or more command signals (302a₁)-(302aₙ). Each command signal (302a₁)-(302aₙ) encodes a respective at least one command to control at least one corresponding feature of the bottom-hole assembly BHA (110). For instance, a command can vary a tool operating mode, a steering reference and/or a steering target. In some cases, a single command signal (302a) can encode multiple commands.

In at least one example, the commands-encoded in the downlink signal—are generated by the control system (114) automatically, or partially automatically. In other examples, the commands are generated by an operator associated with control system (114), e.g., using an input interface (902f) (FIG. 9B).

Each command signal (302a) comprises a modulated flow configuration. In the illustrated examples, the flow is modulated between at least three flow states. The flow states can correspond to three different flow rates and/or three different fluid pressures.

Each command signal (302a) spans over a corresponding command time (CT) interval (304a₁)-(304n₁). Time intervals (304a₁)-(304n₁) are not necessarily of equal duration. In some examples, a command signal—with a shorter time interval—is selected to encode a frequently-used command. Accordingly, the frequently-used command is transmitted more quickly. In turn, aggregate time savings are achieved each time the command is transmitted to the BHA (110). In contrast, a command signal with a longer time interval is assignable to less-frequently used commands.

As shown, stop periods (306a) can separate consecutive command signals (302a). Stop periods (306a) demarcate the end of a previous command signal (302a), and the start of a new command signal (306a). In some examples, the stop period (306a) is sufficiently long to enable the BHA (110) to establish initial conditions for the next command signal (302a).

Reference is now concurrently made to FIGS. 3B and 3D, which show plots (300b) and (300d) of an example command signal (302a) used in downlink communication.

As shown, a single command signal (302a) extends temporally between a start command time (310b₁), and an end command time (310b₂). The time interval-between the start and end times-defines the command time (“CT”) (304a). The CT (304a) is therefore the total time duration for transmitting the command signal (302a).

Within the command time (304a), command signal (302a) comprises a modulated flow configuration defined by at least three variations in flow state. These variations include: (i) a first flow state (302b₁), (ii) a second flow state (302b₂), and (iii) a third flow state (302b₃).

The first flow state (302b₁) is also referenced herein as the “base flow state”. The base flow state expresses the normal flow properties, prior to generating the command signal (302a). In some examples, the base flow state is simply the normal flow rate and/or pressure of the system configured by pump system (114) and/or flow diverter (120).

The second flow state (302b₂) is also referenced herein as an “intermediate flow state”. The intermediate flow state (302b₂) is typically a transition state between the base flow state (302b₁) and the modified flow state (302b₃). As explained, the intermediate state (302b₂) is also used to define a trigger signature for the command signal (302a). In some examples, there may be more than one intermediate flow state, such that it can be said that there is at least one intermediate or second flow state.

The third flow state (302b₃) is also referenced herein as a “modified flow state”. The modified flow state (302b₃) is used for encoding different command types into the command signal, as explained below.

FIG. 3B exemplifies a first configuration, where flow properties are decreased between the first, second and third states. That is, the flow rate and/or pressure is reduced, or throttled, between the base state (302b₁) and the second and third states (302b₂), (302b₃), respectively.

FIG. 3D exemplifies a second configuration, where flow properties are increased between the first, second and third states. That is, the flow rate and/or pressure is increased, or boosted, from the base state (302b₁) and the second and third states (302b₂), (302b₃), respectively.

In either case, the modification of the flow state is realized in one of several ways, as previously noted. For example, the control system (114) can control the pump strokes, in pump system (112), to modify the flow properties to different states. Otherwise, the flow diverter (120) is also controllable to divert greater or less flow, to also modify the flow properties.

To that end, a downlink signal—as shown in FIG. 3A—can include command signals comprising one or both of: (i) the first modulated flow configuration (FIG. 3B), and/or (ii) the second modulated flow configuration (FIG. 3D).

Within a given flow configuration (FIG. 3B or 3D), the flow states are definable in any manner. In at least one embodiment, the flow states are defined in relative terms. For example, the second and third flow states (302b₂), (302b₃) are pre-defined relative to, or with reference to, the first base state (302b₁). In some examples, the differences in flow states are such as to allow unambiguous resolution and/or reliable detectability of the different flow states by the sensor subsystem of the bottom-hole assembly (110).

By way of example, the third flow state (302b₃) can be defined as ±30% flow rate and/or pressure above, or below, the base flow state (302b₁). In at least one non-limiting example, the third flow state (302b₃) may be approximately a 10%~20% reduction (or increase) in flow rate, relative to the first flow state (302b₁). Further, the intermediate flow state (302b₂) can be pre-defined as somewhere between the first and third states (e.g., mid-way). The relative state configuration can be variable and/or user-configurable, e.g., by an operator of control system (114).

With continued reference to FIGS. 3B and 3D, the command signal (302a) can include three command signal portions: (i) a trigger signature portion (304_{b})—this identifies the start of the command signal to the bottom-hole assembly (BHA) (110), (ii) a modified flow portion (306b)—this is used for encoding different commands into the command signal, and (iii) a return flow portion (308b)—this allows the flow properties to return back to the base state (302b₁), and otherwise signifies the end of the command signal (302a) to the BHA (110).

The various command signal portions are now explained in greater detail, below.

### (i) Trigger Signature Portion.

The trigger signature (304b) signals the existence of the command signal to the bottom-hole assembly BHA (110). This allows the BHA (110) to explicitly identify the start of the command signal (302a). Upon detecting the trigger signature (304b), BHA (110) can monitor, and otherwise decode the encoded command.

While any configuration for a trigger signature (304b) is possible—in examples provided herein, the trigger signature (304b) is selected to have a modulated flow configuration that is unlikely to be inadvertently replicated in the normal course of operation of the drilling system. In this manner, the command signal is clearly identifiable to the BHA (110), i.e., distinguishable from other variations in flow rate and/or pressure, unrelated to a command signal.

In the exemplified embodiments (FIGS. 3B and 3D), the trigger signature (304b) has a flow pattern comprising three segments: (i) a first transition segment (312b), (ii) a plateau segment (314b), and (iii) a second transition segment (316b).

As shown, the first transition segment (312b) occurs between the base state (302b₁) and the intermediate state (302b₂). The plateau segment (314b) is a period of substantially steady flow properties at the intermediate state (302b₂). The second transition segment (314b) occurs between the intermediate state (302b₂) and the modified state (302b₃).

For each segment, the flow configuration is variable or adjustable (e.g., user adjustable). For instance, the transitions (310b, 314b) can have any pre-defined rate of change. To that end, the first transition (310b) may have the same, or a different rate of change than the second transition (312b). Likewise, the plateau (312b) can have any configurable length. In some examples, the plateau (312b) may not necessarily extend exactly along the intermediate flow state (302b₂), but is otherwise consistently within a range (e.g., narrow range) of the intermediate flow state, e.g., +5 rate or pressure units of the intermediate state.

A unique feature, of the exemplified trigger signature (304b), is that the trigger signature (304b) is identified by relative changes in flow properties, e.g., a transition-plateau-transition. Accordingly, the trigger signature (304b) is not otherwise identified based on detecting specific, or absolute, flow property values. This, in turn, allows the trigger signature to be inserted anywhere in the flow, irrespective of the initial base flow state.

To further clarify this concept, reference is briefly made to FIG. 3C, which shows a plot (300c) including a plurality of command signals (302a₁)-(302a₃).

As shown, each command signal (302a₁)-(302a₃) initiates from a different base flow state (302b₁). However, notwithstanding this fact, each signal is still identifiable to the bottom-hole assembly (BHA) (110) based on relative (e.g., delta) flow changes, identifying the trigger signature (304b), e.g., a transition-plateau-transition.

For instance, during the stop period (306a)—the flow rate or pressure is adjusted, by control system (114), during normal course of operation. However, a command signal (302a) is still identified by detecting: (i) a first transition from a base state to the intermediate state, (ii) a plateau at the intermediate state, and (iii) a second transition to the modified state. On this point, each command signal (302a₁)-(302a₃) has a different intermediate state (302b₂) and modified state (302b₃), defined relative to the respective base state (302b₁).

In view of the foregoing, embodiments herein allow a command signal (302a) to be generated, irrespective of the current base flow state (302b₁). In turn, command signals are transmitted while flexibly accommodating normal operation of the drilling system.

Referring back to FIGS. 3B and 3D, the trigger signature (304b) extends a corresponding trigger signature time interval (350b). Trigger signature time interval (350b) may initiate at the command start time (310b₁), which also functions as the signature start time. The trigger signature (304b) then extends to the trigger signature end time (310b₃), corresponding to the start of the modified flow portion (306b).

### (ii) Modified Flow Portion.

The modified flow portion (306b) is the period of time where the flow properties are maintained at the third, modified flow state (302b₃).

The modified flow portion (306b) spans a time interval referenced herein as the “command divisor time” (CDT) (352b). The CDT (352b) spans from a modified flow start time (310b₃), to a modified flow end time (310b₄). The start time (310b₃) may be the same as the signature end time (310b₃). The end time (352b₄) correspond to the time point, or instance, when the flow properties are no longer at the modified flow state (302b₃).

As provided below, different commands are encoded into the ratio of the total command time (CT) (304a) and the command divisor time (CDT) (352b).

(iii) Return Flow Portion.

The return flow portion (308b) expresses the portion, of the command signal (302a), where the flow rate returns from the modified flow state (302b₃) back to the base flow state (310b₁).

As shown in FIGS. 3B and 3D, the return flow portion (308b) commences at the end of the modified flow portion (306b), and at time instance (310b₄). The return flow portion (308b) then terminates at the time instance (310b₂). Time instance (310b₂) is the point-in-time when the flow properties return back to the base flow state (302b₁), which also signifies the end of the command time (CT) (304a). As used herein, the return time (354b) is the time interval between the start and end of the modified flow portion (308b).

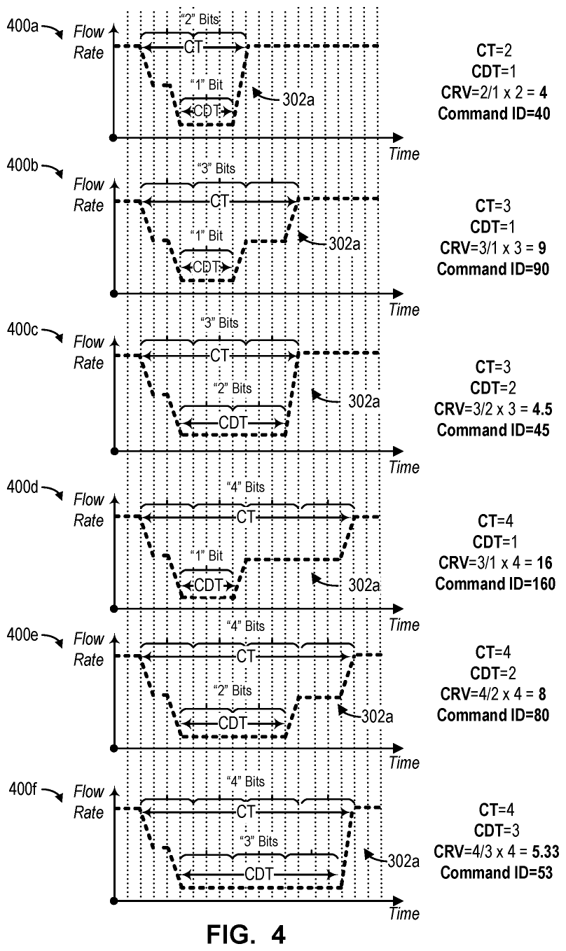

In at least one example, within the return flow portion (308b)—the flow properties return directly to the base rate (302b₁) (FIG. 3B or 3D). In other examples, the flow properties may not directly return to the base state. For example, the flow properties may first graduate to the intermediate state (302b₂), before returning to the base state (302b₁) (see e.g., plots 400d-400f in FIG. 4).

### V. ENCODING COMMANDS INTO DOWNLINK COMMAND SIGNALS

In accordance with embodiments herein, commands are encoded into a ratio of the command time (CT) (304a) and the command divisor time (CDT) (352b) (FIGS. 3B and 3D).

In at least one example, a command ratio value (CRV) is defined, which is a ratio of the command time (CT) (304a) and the command divisor time (CDT) (352b), as expressed by Equation (1). As explained, each command may be assigned a different CRV.

$$Command Ratio Value ( CRV ) = CT / CDT \times CT \qquad ( 1 )$$

To further clarify this concept, reference is made to FIG. 4, which shows various plots (400a)-(400f) for different command signals (302a), encoding different command ratio values (CRVs).

Plot (400a) is a simplified example, where the command signal (302a) has a command time (CT) (304a) of “2” bit units, and a command divisor time (CDT) (352b) of “1” bit unit. In this example, the command ratio value (CRV) is “4”, according to Equation (1). A CRV of “4” can be assigned to a specific command (e.g., a command to adjust a tool face).

To that end, a bit unit may correspond to any configurable time-period. For instance, a bit unit may correspond to 10 seconds, 15 seconds or 30 seconds. In some examples, the time span of a bit unit is configurable by an operator of control system (114).

Referring still to FIG. 4, by adjusting the command time (CT) and/or command divisor time (CDT), in the command signal—the command signal can encode different CRVs. In turn, the command signal can encode different commands.

By way of example, in plots (400a) and (400b), the command divisor time (CDT) time is “1” bit unit. However, in plot (400a) the command time (CT) is “2” bits, while the CT is “3” bits in plot (400b). In turn, the command signal in plot (400a) has a CRV of “4”, while the command signal in plot (400b) has a CRV of “9”. Again, each of CRV “4” and “9” can be assigned to different types of commands.

By a similar token, the command time (CT) is identical between the command signals in plots (400b) to (400c) (i.e., “3” bits). However, in each case, the command divisor (CD) time is varied to generate different CRVs.

As shown in Table 1, the system pre-assigns different CRVs to different command types. In some examples, a single CRV can also encode a plurality of commands, such as a sequence or combination of commands performed in sequential or non-sequential order by the bottom-hole assembly (BHA) (110).

TABLE 1
Example CRV Assignment

| CRV | Command Type |
|---|---|
| 4 | Command Type #1 |
| | (e.g., Set tool operating) |
| 4.5 | Command Type #2 |
| | (e.g., Select steering reference field) |
| 5.3 | Command Type #3 |
| | (e.g., Adjust steering value) |
| 8.0 | Command Type #4 |
| | (e.g., Set sensor logging configuration) |
| 9.0 | Command Type #5 |
| 16.0 | Command Combination |

Example commands assigned to CRVs include: (i) selecting a tool operating mode (e.g., off, manual, inclination & azimuthal hold, automatic); (ii) selecting a steering reference field (e.g., gravity steering, magnetic steering, hybrid steering); and/or (iii) applying a “set” or “nudge” command to adjust steering target (e.g., adjust target tool face, adjust target bias/deflection, adjust target inclination, adjust target azimuth). A nudge command provides smaller increment or decrement change in the target, while a “set” command includes “low start” and “high start” options (i.e., to minimize time taken to complete the downlink).

In Equation (1), the multiplication of CT to the ratio of CT/CDT ensures there are no duplicate CRVs, and that each CRV is unique.

In at least one example, a set multiplier (e.g., 10) is applied to the CRV to generate a command ID (see e.g., Table 2). This can accommodate floating point values, as shown in FIG. 4. After applying the multiplier, any remaining decimal points can be either removed or rounded. In other cases, the command ID can be any other derivative value of the CRV, or it can just simply be the CRV with no modification.

TABLE 2
Example Command ID Assignment

| Command ID | Command Type |
|---|---|
| 40 | Command Type #1 |
| | (e.g., Set tool operating) |
| 45 | Command Type #2 |
| | (e.g., Select steering reference field) |
| 53 | Command Type #3 |
| | (e.g., Adjust steering value) |
| 80 | Command Type #4 |
| | (e.g., Set sensor logging configuration) |
| 90 | Command Type #5 |
| 160 | Command Combination |

Each of the control system (114) and BHA (110) can store a common assignment mapping between command IDs (or CRVs) and command types. For example, this can involve storing a reference look-up table (e.g., Tables 1 or 2) in either system's respective memories. This provides a common basis for control system (114) and BHA (110) to communicate by respectively encoding and decoding commands in control signals.

By way of example, if the surface control system (114) transmits the command type #1 to the BHA (110) (i.e., Tables 1 or 2)—control system (114) can control the flow properties to generate a command signal having a CRV=4, as shown in plot (400a).

Subsequently, when the BHA (110) receives a command signal, as shown in plot (400a)—BHA (110) can determine that the CRV=4, which corresponds to a command ID of “40” (or simply “4”), is associated with command type #1.

Here, a number of advantages of the described encoding/decoding method will now become apparent.

First, as noted, the command is encoded as a ratio of the command time (CT) (304a) and the command divisor time (CDT) (352b). In this manner, the encoded command is tied to a ratio, and not tied to a particular “bit period”, i.e., as contrasted to existing encoding techniques for downlink communication (e.g., Manchester encoding, pulse position, etc.).

Accordingly, while prior techniques require the same amount of time to transmit each command using a fixed number of bits—in the disclosed embodiments, and as best shown in FIG. 4, the command signal is configurable to require less or more time to transmit (plots 400a versus 400d-400f). This is achieved by adjusting the command time (CT) and the command divisor time (CDT).

This property offers several important benefits. For example, more frequently-transmitted commands can be assigned to command signals with shorter transmission periods, or CT lengths (e.g., plot 400a). This allows aggregate time savings each time the command is transmitted to the BHA (110). In contrast, less-frequently transmitted commands are assignable to control signals with longer command times (e.g. plot 400d-400f).

By way of further example, in FIG. 4 and Tables 1 and 2, a frequently transmitted command can be assigned a command ID of “40” (i.e., a CRV=“4”), which has a shorter CT. In contrast, a less frequently used command is assignable a command ID of “53”, “80” or “160”, which have longer CTs. Accordingly, this allows for more optimized time transmission.

A second appreciated advantage is that command signals are generated with less physical control switching of the pump system (112) and/or flow diverter (120).

For example, in a Manchester encoding scheme (FIG. 2A), or pulse position encoding (FIG. 2B)—pump system (112) and/or flow diverter (120) are controlled each time the flow rate is varied.

More specifically, in FIG. 2A (i.e., Manchester method), to transmit a single command, the flow rate is varied thirteen (13) times. This requires thirteen adjustments to the pump strokes in pump system (112) and/or valve switches in the flow diverter (120). This adds mechanical stress to the system, especially where the adjustments are effected in close time proximity.

By contrast, in FIG. 3B or 3D, the command signal requires only six adjustments to the flow rate. Accordingly, the disclosed encoding method has a physical implication in reducing mechanical stress on the pump system (112) and/or flow diverter (120).

Still additionally, in FIG. 2A (Manchester method), the 6-bit sequence enables encoding only 64 commands. If it is desired to increase the range of encoded commands, the number of transmitted bits must also increase (i.e., from 6 bits to 7 or 8 bits). In turn, this requires additional adjustments to the flow rate to accommodate each new bit. In other words, in FIG. 2A, the mechanical stress is increased to accommodate a greater number of bits, and a greater range of commands.

In contrast, in the disclosed method-increasing the range of commands does not necessitate encoding further bits. Rather, as shown in FIG. 4, increasing the number of encoded commands occurs by incrementing the command time (CT). By incrementing the CT, a greater range of CRVs are available in Equation (1), which are assignable to a greater number of command combinations (see e.g., plots 400d-400f). Therefore, in FIG. 4, increasing the command time—to accommodate more commands-does not necessitate additional adjustments to flow properties, as in FIGS. 2A and 2B. For instance, the same number of adjustments to pump strokes or flow valves are required in plot (400a) as in plot (400f), in FIG. 4. Accordingly, increasing the combination of commands does not add mechanical stress to the system.

### VI. DOWNLINK SIGNAL INCLUDING DATA PAYLOAD

In some examples, the downlink signal can also include a data payload signal portion. The data payload can carry additional data to supplement the command signal. For example, the command signal may include a command to change the target tool face. Accordingly, the data payload can encode the desired target value, for the adjusted target tool face.

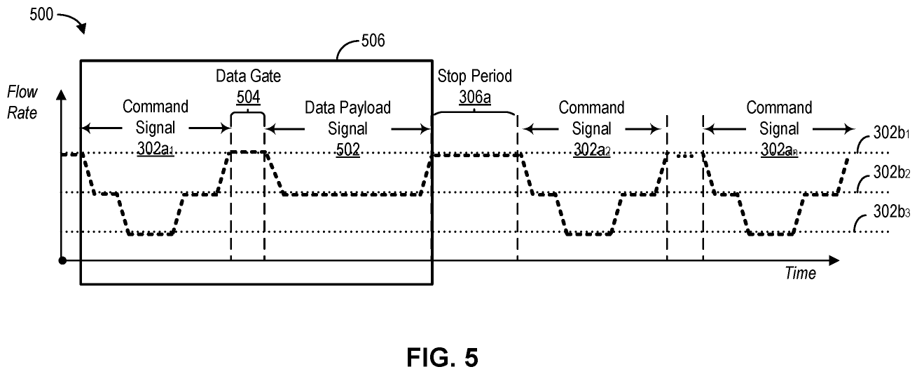

Reference is made to FIG. 5, which shows a plot (500) of an example downlink signal (506).

As shown, a downlink signal (506) is generated, and transmitted by the control system (114) which includes: (i) a command signal portion (302a₁), and (ii) a data payload signal portion (502). The data payload signal (502) is associated with the control signal (302a₁). In some examples, the data payload signal (502) encodes further command data, as explained.

In the exemplified case, the data payload signal (502) follows temporally and sequentially after the command signal (302a₁). In other examples, the data payload signal (502) can be located in any positional relation, relative to the command signal (e.g., before the command signal).

In at least one example, the data payload signal (502) is transmitted within a pre-determined time period, following the associated command signal (302a₁). This time period is also referred to herein as a “data gate” period (504). If the BHA (110) detects a data payload signal (502), within the pre-defined data gate period (504), the BHA (110) can associate the data payload with the previously transmitted command signal (302a₁).

The same concept can apply if the data payload signal (502) precedes the command signal (302a₁). For example, the command signal (302a₁) should follow the data payload signal (502), within the defined data gate period (504), to be associated with the command signal (302a₁).

In some examples, it may not be necessary to include a data gate period (504). For example, the BHA (110) may have pre-defined knowledge that certain commands are transmitted with an associated data payload signal (502). Accordingly, once a command signal is received, the BHA (110) can decode the signal to determine the command type. BHA (11) can then further determine that this command type is typically followed by a data payload signal (502). Accordingly, the BHA (110) will then monitor to receive the associated data payload signal (502).

The data payload signal (502) can have any suitable configuration to encode the payload data. In at least one example, best shown in FIG. 5, the data component extends along the intermediate flow state (302b₂). Accordingly, there is a transition to, and from the base flow state (302b₁) to the intermediate flow state (302b₂). The temporal length of the data payload signal, at the intermediate flow state (302b₂) (referred to herein as the “data period”), is then directly proportional to the transmitted data component. For example, the BHA (110) can store pre-defined data correlating different lengths of the data period to different transmitted data (e.g., in a look-up table). The scaling of this data period may be determined, in some examples, by the preceding command signal.

### VII. EXAMPLE TRANSMISSION TIMES FOR DOWNLINK SIGNALS

Tables 3-5, below, exemplify different transmission times for transmitting downlink signals with different bit times (e.g., 10 seconds, 15 seconds and 30 seconds). The tables below assume a data time (DT) of 90 seconds, i.e., for the data payload signal. The bit time is modified to control the overall transmission time. The choice of the bit period does not affect the encoding/decoding process, as this process is based on relative ratios of command time (CT) (304a) and command divisor time (CDT) (352b), and not absolute bit time values.

As shown, on average the total downlink time can be configured to be less than 3 minutes total to transmit both a command and data payload signal. This presents an improvement over existing methods, which require an average of between 4 to 15 minutes to transmit a single command signal.

TABLE 3
Total time for transmitting downlink signal (Bit time = 10 seconds)

| | Bit Time | | | | | |
|---|---|---|---|---|---|---|
| | (seconds) | | | | | |
| | 10 seconds | | Total | | | |
| | Command | | Downlink | Total | Commands | |
| | Time | Data Time | Time | Downlink | Available | |
| | (CT) | (DT) | (CT + DT | Time | (using | Commands |
| Bits | (seconds) | (seconds) | Seconds) | (minutes) | this CT) | Available |
| 2 | 20 | 90 | 110 | 1.83 | 1 | 1 |
| 3 | 30 | 90 | 120 | 2.00 | 2 | 3 |
| 4 | 40 | 90 | 130 | 2.17 | 3 | 6 |
| 5 | 50 | 90 | 140 | 2.33 | 4 | 10 |
| 6 | 60 | 90 | 150 | 2.50 | 5 | 15 |
| 7 | 70 | 90 | 160 | 2.67 | 6 | 21 |
| 8 | 80 | 90 | 170 | 2.83 | 7 | 28 |
| 9 | 90 | 90 | 180 | 3.00 | 8 | 36 |

TABLE 4
Total time for transmitting downlink signal (Bit time = 15 seconds)

| | Bit Time | | | | | |
|---|---|---|---|---|---|---|
| | (seconds) | | | | | |
| | 15 seconds | | Total | | | |
| | Command | | Downlink | Total | Commands | |
| | Time | Data Time | Time | Downlink | Available | |
| | (CT) | (DT) | (CT + DT | Time | (using | Commands |
| Bits | (seconds) | (seconds) | Seconds) | (minutes) | this CT) | Available |
| 2 | 30 | 90 | 120 | 2.00 | 1 | 1 |
| 3 | 45 | 90 | 135 | 2.25 | 2 | 3 |
| 4 | 60 | 90 | 150 | 2.50 | 3 | 6 |
| 5 | 75 | 90 | 165 | 2.75 | 4 | 10 |
| 6 | 90 | 90 | 180 | 3.00 | 5 | 15 |
| 7 | 105 | 90 | 195 | 3.25 | 6 | 21 |
| 8 | 120 | 90 | 210 | 3.50 | 7 | 28 |
| 9 | 135 | 90 | 225 | 3.75 | 8 | 36 |

TABLE 5
Total time for transmitting downlink signal (Bit time = 30 seconds)

| | Bit Time | | | | | |
|---|---|---|---|---|---|---|
| | (seconds) | | | | | |
| | 30 seconds | | Total | | | |
| | Command | | Downlink | Total | Commands | |
| | Time | Data Time | Time | Downlink | Available | |
| | (CT) | (DT) | (CT + DT | Time | (using | Commands |
| Bits | (seconds) | (seconds) | Seconds) | (minutes) | this CT) | Available |
| 2 | 60 | 90 | 150 | 2.50 | 1 | 1 |
| 3 | 90 | 90 | 180 | 3.00 | 2 | 3 |
| 4 | 120 | 90 | 210 | 3.50 | 3 | 6 |
| 5 | 150 | 90 | 240 | 4.00 | 4 | 10 |
| 6 | 180 | 90 | 270 | 4.50 | 5 | 15 |
| 7 | 210 | 90 | 300 | 5.00 | 6 | 21 |
| 8 | 240 | 90 | 330 | 5.50 | 7 | 28 |
| 9 | 270 | 90 | 360 | 6.00 | 8 | 36 |

### VIII. EXAMPLE METHODS OF OPERATION

The following is a discussion of various methods for operating a drilling system for downlink communication.

### (i) Example Overall Operation.

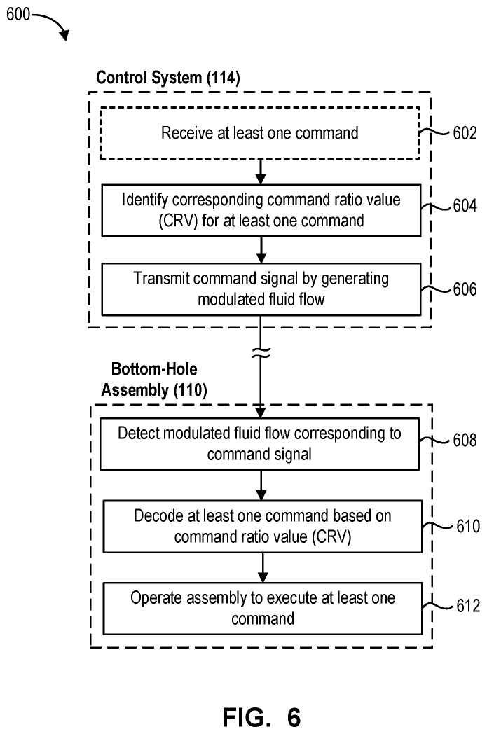

Reference is now made to FIG. 6, which shows a process flow for an example method (600) for transmitting downlink signals in a drilling system.

Method (600) broadly includes two segments: (i) initially, generating and transmitting the downlink signal by the control system (114) (i.e., acts 602-606); and (ii) subsequently, receiving and decoding the downlink signal by the bottom-hole assembly (BHA) (110) (i.e., 608-612).

Now in more detail, at (602), control system (114) can, in some cases, receive parameters for at least one command to be transmitted to the BHA (110). For instance, the command can involve adjusting a tool face, and the command parameter is the extent to which the tool face should be adjusted.

In some examples, the command and command parameters are received from an operator of the control system (114). For example, an operator may input a “set” or “nudge” command, to adjust a directional feature of the BHA (110) (e.g., tool face, bias/deflection, inclination or azimuth). The command may be input by the operator into the input interface (960) of the control system (114) (FIG. 9B). In other cases, the command may be input through a remote a system, which is in communication (e.g., wired or wireless) with the control system (114).

In other examples, the command is not necessarily “received” by control system (114). For example, the command may be automatically retrieved from a control system memory (952). For instance, the control system (114) can transmit specific pre-defined commands at pre-defined time instances, and/or in response to detecting specific events.

At (604), the control system (114) determines a command ratio value (CRV), associated with the at least one command. For example, the control system memory (952) can store pre-defined assignment data. The assignment data correlates commands and their respective command IDs. In some examples, as shown in Tables 1 or 2 (above), the assignment data is formatted as a look-up reference table. The assignment data is also retrievable (or access able) from any other internal or external memory.

As noted above, the command ID—in the assignment data—can have several forms. In a simple case, the command ID is simply the command ratio value (CRV). Accordingly, at (604), the system determines the CRV by simply retrieving the command ID.

In other examples, the command ID is a derivative of the CRV. For instance, in Table 2, the command ID is the CRV multiplied by a factor of ten. In this case, at (604), the control system (114) converts the command ID into the CRV.

In some examples, assignment data is not necessarily pre-defined. For example, the control system (114) can also assign a command to a CRV “on-the-fly”, e.g., in real-time or near real-time.

At (606), control system (114) modifies, or modulates, the drilling fluid flow properties to encode the command, based on the CRV. The modulated flow properties can correspond to either flow rate and/or fluid pressure.

For example, in FIG. 4, control system (114) can generate a “tri-state” command signal (302a) having a command time (CT) and a command divisor time (CDT), for generating the desired CRV at (604). In this manner, the control system (114) encodes the command into the fluid properties. In turn, the control system (114) generates a modulated fluid flow, corresponding to the command signal.

In some examples, control system (114) can generate a downlink signal which also includes a data payload. The data payload is encoded into a second modulated flow.

At (608), at a subsequent point-in-time, the bottom-hole assembly (BHA) (110) detects the modulated fluid flow, corresponding to the command signal (302a). The modulated fluid flow is detectable in several ways. For example, the BHA (110) can include a sensor system (912) (FIG. 9A), which includes sensors for monitoring downhole flow rate and/or fluid pressure. This can include pressure transducers and/or flow rate sensors.

In other examples, the modulated fluid flow is monitored and detected in-directly by sensing the rotation rate of a turbine (916), driven by the drilling fluid. For instance, a higher rotation per minute (RPM) indicates increase flow rate and/or pressure, while a lower RPM indicates decreased flow rate and/or pressure.

The BHA (110) can also monitor and detect the data payload signal, included in the downlink signal.

At (610), the BHA (110) analyzes the modulated fluid flow-corresponding to the command signal—to determine the command ratio value (CRV). The CRV is determined based on determining the command time (CT) and command divisor time (CDT) in the modulated fluid flow, e.g., in accordance with Equation (1).

Similar to control system (114), BHA (110) can also store the pre-defined assignment data, correlating command IDs to different command types. Using the assignment data, BHA (110) can determine the at least one command which is associated with the determined CRV. The assignment data can be stored, for example, in the BHA's (110) memory database (906) (FIG. 9A), e.g., in the form of a reference look-up table. As noted, the command ID may be either the CRV, or a derivative of the CRV.

At (612), the BHA (110) can operate the assembly to execute the decoded at least one command (and data payload). For example, this can involve controlling the steering actuation system (910) to control directional properties of the drill bit (914) (FIG. 9A).

### (ii) Example Method for Operating Control System (114).

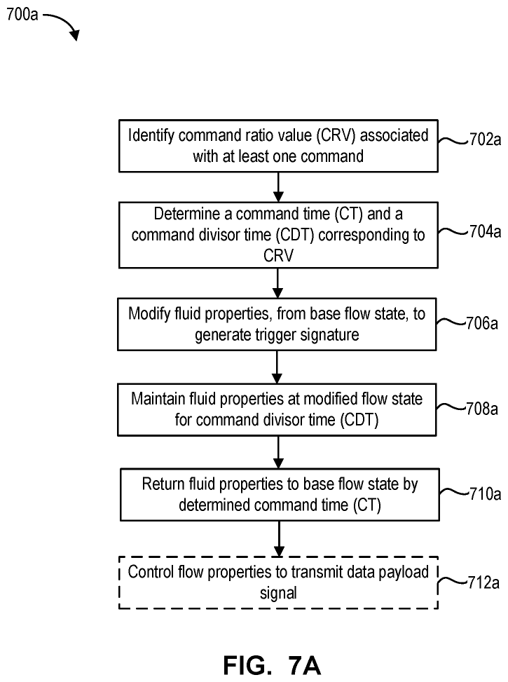

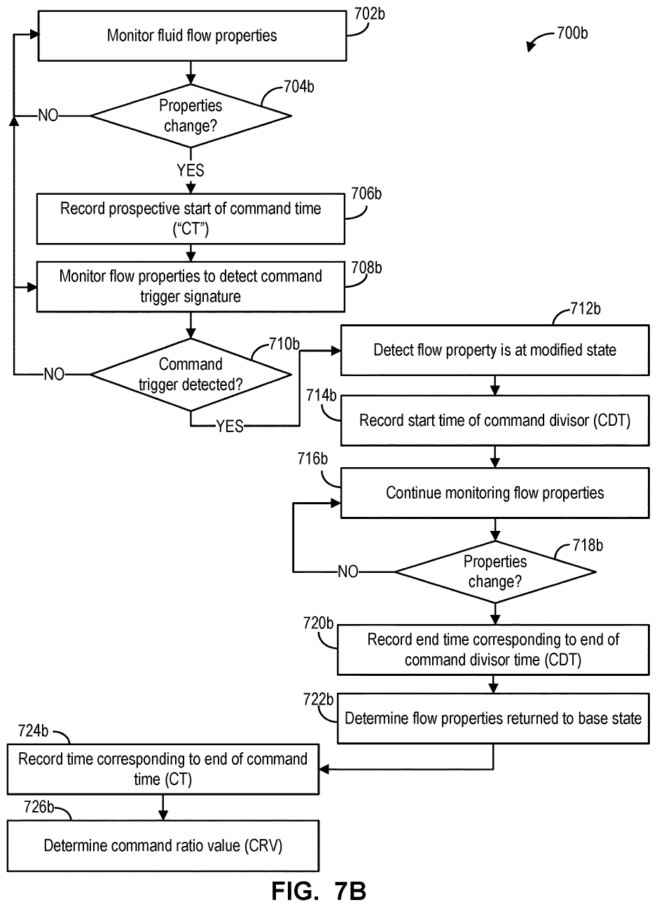

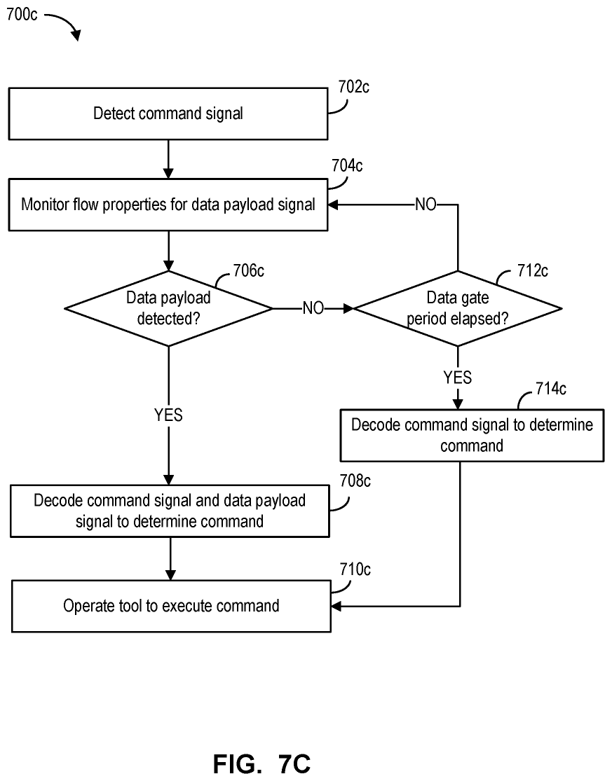

Reference is now made to FIG. 7A, which shows, in further detail, an example method (700a) for operating the control system (114) for downlink communication. Method (700a) can be performed, for example, by the processor (950) of control system (114) (FIG. 9B).

At (702a), the control system (114) identifies the CRV associated with a received at least one command, e.g., as explained at act (604) (FIG. 6).

At (704a), the control system (114) can determine the command time (CT) and a command divisor time (CDT) corresponding to the CRV, e.g., in accordance with Equation (1).

In some examples, as shown in FIG. 4, each of the CT and CDT is expressed by a number of “bit units”. The system can define a time length for each unit in advance in order to generate the CT and CDT.

As the command time (CT) also includes the trigger signature time (350b) (FIG. 3B)—at (704a), the CDT is selected to accommodate for the time remaining in the CT, after inserting the trigger signature time (350b).

At (706a), the control system (114) modifies, or modulates, the fluid properties to generate the trigger signature (350b).

For example, in FIG. 3B or 3D, this involves initially generating the first transition (312b) between the base state (302b₁) and a pre-defined intermediate state (302b₂), then further plateauing (314b) at the intermediate state (302b₂), and then generating the second transition (316b) to the pre-defined modified state (302b₃).

As noted earlier, modulating the fluid properties is performed in one of several ways. For example, control system (114) may control the pump strokes of the pump system (112) (FIG. 1). In another case, control system (114) can control the flow diverter (120), e.g., control the diverter vales to modify the flow rate and/or pressure.

At (708a), the control system (114) controls the flow properties at the modified states for a time interval corresponding to the desired command divisor time (CDT), determined at (704a).

At (710a), the control system (114) returns the fluid properties back to the initial base state to conclude the command signal transmission.

At (712a), in some examples, the fluid properties are also modified to subsequently transmit the data payload signal. As shown in FIG. 5, the data payload signal is transmitted within a data gate period (504) of the associated command signal (302a).

(iii) Example Method for Operating Bottom-Hole Assembly (BHA) (110).

Reference is now made to FIG. 7B, which shows, in further detail, an example method (700b) for operating the BHA (110) for downlink communication. Method (700b) can be performed by the controller (902)—e.g., processor (904a)—of BHA (110) (FIG. 9A).

At (702b), the BHA (110) monitors the flow properties of drilling fluid conveyed to the BHA (110) (e.g., flow rate and/or pressure). As explained with reference to (608) in FIG. 6, the flow properties can be monitored via the BHA's sensor system (912).

At (704b), the BHA (110) determines if there is a change in the flow properties. If not, the method can return to (702b) to continue monitoring. Otherwise, if a change is detected, then at (706b), the time instance-corresponding to the change—is recorded as a prospective start of the command time (CT), e.g., time instance (310b₁) in FIG. 3B. However, it should be noted that at this instance, it is not yet confirmed if the change in flow properties does, in fact, correspond to a command signal.

At (708b), in response to the changing flow properties, BHA (110) begins monitoring for the command trigger signature (304b). If the trigger signature is detected, this indicates that the changing flow properties correspond to a command signal.

To detect the trigger signature (304b), BHA (110) may store pre-determined flow configuration for the trigger signature, e.g., in memory database 906 (FIG. 9A). BHA (110) then evaluates whether the detected flow configurations correspond to the expected flow configuration for the trigger signature.

To that end, the expected flow configuration for the trigger signature (304b) can include: (i) the expected signature pattern (e.g., transition-plateau-transition); (ii) the expected rate of change of the first and second transitions (312b), (316b) (FIG. 3B); and/or (iii) the expected duration of time for the plateau (314b).

More generally, in monitoring the flow configuration, the BHA (110) and control system (114) share a common understanding of how the intermediate and modified states are defined relative to the base state. For example, the BHA (110) and control system (114) can share a common understanding that the intermediate state is at 10% increase/decrease of the base state, and the modified state is at 20% increase/decrease of the base state.

At (710b), the BHA (110) determines if the trigger signature is detected. If the trigger signature (304b) is detected, then the BHA (110) determines that a command signal is being transmitted, and proceeds to act (712b).

Otherwise, if the trigger signature is not detected, the method can return to either acts (708b) or (702b).

In some examples, the method initially returns to (708b) to continue monitoring for the trigger signature. However, if one or more monitoring conditions are satisfied, the method returns further back to (702b), to continue monitoring the flow properties more generally.

Monitoring conditions may involve, for example, a timeout interval. If a timeout period passes, and no trigger signature is detected—the method may simply abort monitoring for the trigger signature, and return back to (702b).

In another case, the monitoring condition is that the detected flow properties are contrary to the expected flow configuration, for the trigger signature. This can indicate that the changing flow properties are not a command signal. Therefore, the system can abort monitoring for the trigger signature, and return back to (702b).

At (712b), if the command trigger signature (304b) is detected-BHA (110) can determine when the flow properties are at the modified state. This corresponds to the start of the modified flow portion (306b) (FIGS. 3B and 3D).

At (714b), the BHA (110) can record the start time of the modified flow state (306b), which is also the start of the command divisor time (CDT) (352b) (FIGS. 3B and 3D).

At (716b), the BHA (110) can continue monitoring the flow properties to detect any changes from the modified flow state (302b₃). At (718b), a determination is made as to whether the flow properties have changed from the modified state. If not, the method can return to (716b) to continue monitoring, otherwise the method proceeds to (720b) to record the change as the end of the command divisor time (CDT) (i.e., 310b₄ in FIGS. 3B and 3D).

At (722b), the BHA (110) monitors to determine that the flow properties have returned back to the base state (302b₁). At (724b), the BHA (110) records this time as the command end time (310b₂) (FIGS. 3B and 3D) for the command time (CT) (304a).

At (726b), the BHA (110) can determine the command ratio value (CRV), e.g., in accordance with Equation (1). For example, the BHA (110) can determine the command time (CT) (304a) based on the start and end times recorded at (706b) and (724b). The CT (304a) can be expressed as a number of bits, wherein each bit corresponds to a pre-defined time window.

Similarly, the BHA (110) can determine the command divisor time (CDT) (352b) based on the start and end times recorded at (714b) and (720b). The CDT can also be expressed by a number of bits, defined by the same bit time window.

Once the command ratio value (CRV) is determined, the at least one command is decoded as previously explained with reference to act (610) in FIG. 6. The at least one command is then used to operate the assembly.

### (iv) Example Method for Operating Bottom-Hole Assembly (BHA) (110) to Receive Downlink Signal Including a Data Payload.

Reference is now made to FIG. 7C, which shows an example method (700c) for operating the BHA (110) for downlink communication. Method (700c) is an extension of method (700b) where the downlink signal additionally includes a data payload signal (502) (FIG. 5).

At (702c), the BHA (110) can detect the command signal, e.g., in accordance with method (700b) (FIG. 7B).

At (704c), once the command signal is detected, the BHA (110) can continue monitoring flow properties for a data payload signal. At (706c), the BHA (110) can determine whether the data payload signal is detected. If a data payload is detected, then at (708c), the BHA (110) can decode the command signal and data payload to determine the transmitted command. At (710c), the BHA (110) can then operate the assembly to execute the command and any associated command parameters.

At (706c), if the data payload is not detected, then the BHA (110) determines whether the data gate period (504) (FIG. 5) has elapsed. If the period has not elapsed, there is still an opportunity to receive the data payload signal. Accordingly, the method can return to (704c) to continue monitoring the flow rate. Otherwise, if the data gate period has elapsed, then at (714c), only the command signal is decoded and executed at (710c).

### (v) Example Method for Modifying Assignment Data Based on Command Transmission Properties.

In some examples, assignment data is dynamically configurable based on transmission properties of commands. For example, as stated previously, commands that are used more-frequently can be assigned command ratio values (CRVs), or command IDs, generated using a shorter-time command signal (see e.g., plots 400a-400c in FIG. 4). Conversely, commands that are used less-frequently are assigned to CRVs that are generated using longer-time command signals (see e.g., plots 400d-400f in FIG. 4).

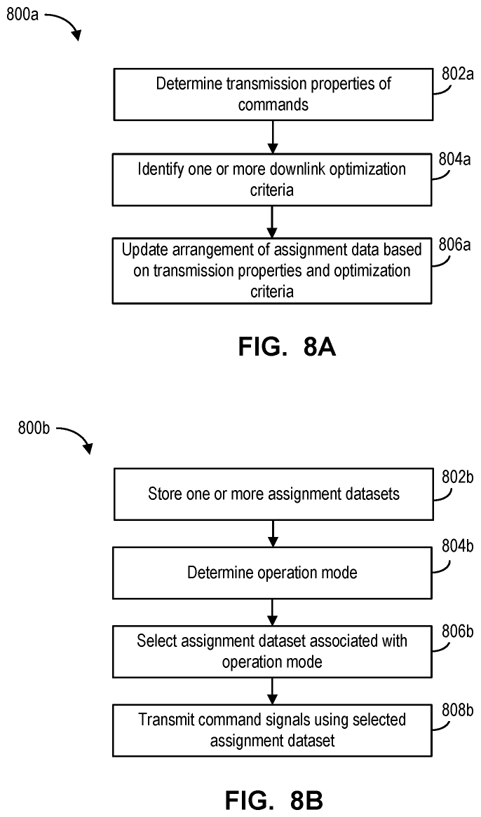

Reference is now made to FIG. 8A, which shows an example method (800a) for configuring assignment data during downlink communication. Method (800a) can be performed by processor (950) of control system (114). In other example, method (800a) can also be performed by controller (902) of bottom-hole assembly (BHA) (110).

As shown, at (802a), transmission properties of different commands (also referred herein as command-specific transmission properties) are monitored.

In at least one example, the transmission properties include how frequently a command was transmitted. For instance, the system can monitor how frequently a command was transmitted over a pre-defined window of time (e.g., hours or days).

In other examples, the transmission properties are externally provided. For example, an operator of the control system (114) can indicate that certain commands are used more frequently than others.

At (804a), one or more downlink optimization criteria are identified. For example, these can include simple rules for how to optimize timed transmission of commands. For instance, the criteria can indicate that more-frequently used commands should be allocated to shorter command signals. In contrast, less-frequently used commands should be allocated to longer command signals.

At (806a), the assignment data (e.g., Tables 1 or 2) are modified to update the assignment pairing of different commands and different command ratio values (CRVs), or command IDs.

For example, more-frequently used commands are allocated to the group of CRVs or command IDs with shorter command times (CTs) (see e.g., plots 400a-400c in FIG. 4). Likewise, less-frequently used commands are allocated to groups of CRVs or command IDS with longer command times (CTs) (see e.g., plots 400d-400f in FIG. 4).

This updated or modified assignment data can be configured, as well, in the BHA (110). For example, this can occur manually when the BHA (110) is still above surface. Alternatively, or in addition, it can be communicated to the BHA (110) in any manner known in the art.

In some examples, method (800a) occurs automatically periodically or consistently in real-time or near real-time in the background during, before and/or after execution of method (600). In other examples, updating of assignments at (806a) can be completely manual. For example, an operator of control system (114) can manually re-configure the assignment data to associate different commands with different command IDs.

### (vi) Example Method for Selecting Between One or More Assignment Datasets.

In some example cases, it is desirable to have separate assignment datasets. For example, separate assignment datasets can be generated for different operation modes. For example, a first assignment dataset is associated with manual control of the bottom-hole assembly (BHA) (110). Further, a second assignment dataset is associated with automated control of the BHA (110).

In these examples, arrangement of assignment data (Tables 1 or 2) may be different for each assignment dataset. This is because some commands can be used more frequently in one dataset, as compared to the other.

Reference is now made to FIG. 8B, which shows an example method (800b) for selecting between one or more assignment datasets during downlink communication. Method (800b) can be performed by processor (950) of control system (114).

At (802b), control system (114) can store one or more assignment datasets, e.g., in memory (952). In some examples, each assignment dataset is associated with a different operation mode for the system.

At (804b), the operation mode of the system is determined. For example, if the control system (114) is being operated by an operator, or receiving external manual commands, it may determine that the operation mode is a “manual mode”. Otherwise, the control system (114) may be operated in “automated” or “auto-pilot” mode.

At (806b), the control system (114) can select the assignment dataset associated with the determined operation mode.

At (808b), the control system (114) can transmit command signals used the selected assignment dataset.

In at least one example, each assignment dataset includes at least one command ratio value (CRV) assigned to activating that dataset (i.e., at least one “activating command”). Accordingly, control system (114) can initially transmit an activating command, which informs the BHA (110) which assignment dataset is to be activated. Subsequently, any other commands transmitted by the control system (114) will be in accordance with the activated assignment dataset.

It is also possible for the reverse case to occur, in which the BHA (110) is the system activating one of a number of assignment datasets. In these cases, the BHA (110) may communicate, to the control system (114), the activated assignment dataset (e.g., using existing MWD data transfer techniques). Subsequently, any other commands transmitted by the control system (114) will be in accordance with the activated assignment dataset.

In at least one example, the dataset assignments are synchronized at the surface, prior to the BHA (110) being deployed. For instance, this includes all assignment datasets to be used on a per deployment basis, e.g., the deployment could use a single assignment dataset, or multiple assignment datasets.

In some examples, it is possible to perform method (800a) for each separate assignment dataset. In this manner, the arrangement of assignment data is updated separately for each dataset. In these cases, the system can monitor the transmission properties of each command for different operation modes, in order to update the associated dataset.

### IX. OTHER EXAMPLE EMBODIMENTS

The following is a description of other example embodiments that can be used in addition to and/or, in alternative to, the embodiments described herein.

### (i) Other Example Command Ratio Values (CRVs).

In Equation (1), the CRV is defined as follows:

$$Command Ratio Value ( CRV ) = CT / CDT \times CT \qquad ( 1 )$$

The CRV may also be more broadly defined as any function expressed as a ratio of the command time (CT) and the command divisor time (CDT). For example, by way of non-limiting example, the CRV can be defined by Equation (2):

$$Command Ratio Value ( CRV ) = CDT / CT \times CDT \qquad ( 2 )$$

To that end, the CRV may be defined by anyone, or combination, of Equations (1) and (2), further modified by any other mathematical operation(s). More generally, the CRV can have any definition that includes some form of ratio of the CT and CDT. (ii) Other Example Command Signals.

In the exemplified embodiments, the command signals (300b, 300d) (FIGS. 3B and 3D) vary between three flow states (302b₁)-(302b₃). In other examples, the command signal may—more broadly—vary between at least two flow states.

For example, the command signal may only vary between two flow states, corresponding to: (i) the first base flow sate (302b₁), and (ii) the third modified flow state (302b₃). Accordingly, the command signal does not include the second intermediate flow state (302b₂). In these examples, the command ratio value (CRV) is still defined and determined, in the same manner described above, as a function of the command time (CT) and command divisor time (CDT) (e.g., Equations (1) and (2)).

In other examples, the command signal can vary between more than three flow states. For instance, the exemplified embodiments illustrate only a single intermediate flow state (302b₂). In other examples, however, the command signal can include at least one intermediate flow state. In other words, the command signal can vary between more than one (e.g., two or more) intermediate flow states.

In these examples, the trigger signature portion (304b) can include more than one intermediate flow state. This may allow the trigger signature (304b) to be defined more uniquely, and otherwise, be distinguishable from other usual changes to the flow rate. In turn, this may prevent inadvertent detection of non-command signals. In other examples, using less intermediate flow states for the trigger signature (304b) may allow for less activations of the pump system (112) and/or flow diverter (120).

It is also possible for the return flow portion (308b) to include more than one intermediate flow state (302b₂). The intermediate flow states (302b₂) for the trigger signature portion (304b) and the return flow portion (308b), can be the same or different.

In cases where there is more than one intermediate flow rate, it is not necessary that the flow progressively increases or decreases between the intermediate flow rates—for example, in the rigger signature (304b), the flow may increase or decrease between intermediate flow rates, in any desirable manner, before arriving at the modified flow rate (302b₃).

Other modifications and variations of the control signals are also contemplated.

For example, while exemplified embodiments illustrate the trigger signature portion (304b) as being adjoined to the modified flow portion (306b)—it is also possible that the command signal can include one or more portions that are interposed between the trigger signature portion (304b) from the modified flow portion (306b). This would not deviate from the teachings herein, whereby the command ratio value (CRV) would still be a function of command time (CT) and command divisor time (CDT). Likewise, there can be other portions that separate the return flow portion (308b) from the modified flow portion (306b).

More generally, any modification of the command signal is contemplated, insofar as it is possible to define and resolve the CRV as a function of the command time (CT) and the command divisor time (CDT).

For example, as best shown in FIGS. 3E and 3F, it is possible that a command signal (300e), (300f) can include more than one modified flow portion (306b). For example, each of FIGS. 3E and 3F show two modified flow portions (306b). In this manner, the command signal is said to, more broadly, have “at least one modified flow portion”. The modified flow portions can be separated, for example, by one or more intermediate flow states (302b₂).

In these examples, each modified flow portion (306b) extends for a corresponding sub-command divisor time (sub-CDT) (352b₁), (352b₂).

In some examples, the sub-CDTs (352b₁), (352b₂) are associated with a single command. For example, the total CDT is determined by the sub-CDTs (e.g., total CDT=First CDT (352b₁)+Second CDT (352b₂)). It is the total CDT which is then used in Equations (1) and (2), to define the CDT for a given CRV.

In other examples, the sub-CDTs (352b₁), (352b₂) are used to encode more than one command, into a single command signal. For example, each of the First CDT (352b₁) and Second CDT (352b₂) can encode a different command. For instance, using Equation (1), a first command is encoded using Equation (la), and a second command is encoded using Equation (1b):

$$Command Ratio Value ( CRV ) of First Command = CT / First CDT \times CT \qquad ( 1 a )$$

$$Command Ratio Value ( CRV ) of Second Command = CT / Second CDT \times CT \qquad ( 1 b )$$

In the examples, it is possible that one or more of the encoded commands requires a corresponding data payload signal. Accordingly, multiple payload sequences could follow the command signal. The order of the commands (e.g., modified flow portions) in the command signal may be directly associated with the order in which the data payload signals (502) are sent or received. The multiple data payload signals may be separated by data gate periods (504).

While FIGS. 3E and 3F illustrate the command signal with only two modified flow portions (306b)—the command signal can also include any number of modified flow portions to encode a single command, or any plurality of commands.

(iii) Uplink Communication.

While examples herein primarily focus on example downlink communication—the same principles and concepts are applied for uplink communication.

In other words, the encoding techniques described herein can also allow for uplink communication between the BHA (110) and the control system (114). For instance, the BHA (110) can vary the flow properties of the fluid flow returning back to the surface such as to encode uplink commands, in the same manner visualized in FIGS. 3A-FIG. 5. The control system (114) can include a sensor system to monitor the varying flow properties, and in turn, decode any transmitted commands or communication data.

Accordingly, in these examples, any one of the methods of FIGS. 7-8 would simply occur in reverse, as between the BHA (110) and control system (114).

### X. EXAMPLE SYSTEM HARDWARE CONFIGURATION

The follow are example hardware configurations for the bottom-hole assembly (BHA) (110) (FIG. 9A), and the control system (114) (FIG. 9B).

Reference is now made to FIG. 9A, which shows a simplified block diagram for an example hardware architecture for a bottom-hole assembly (BHA) (110).

As shown, the BHA (110) can include a controller (902) coupled, via a data bus, to one or more of a memory database (906), a transmitting unit (908), a steering actuation system (910) and/or a sensor system (912).

Memory database (906) can store pre-defined assignment data, correlating a command ratio value (CRV) or command ID, to a particular command. In some example, this is stored in the form of a look-up or reference table. This assignment data can be accessed and referenced, for example, at act (610) in FIG. 6. Database (906) can also store multiple assignment datasets, e.g., associated with different operation modes.

Transmitting unit (908) can be used to transmit uplink communication, e.g., to the control system (114). For example, transmitting unit (908) can be configured for fluid-pulse telemetry and/or electromagnetic telemetry.

Steering actuation system (910) controls the drilling direction, of the BHA (110). For example, in point-the-bit systems, steering actuation system (910) can control the direction of the drill bit (914) relate to the remaining BHA (110) housing. In other example, in push-the-bit systems, the steering actuation system (910) can control one or more pads or ribs, which press against the wellbore to change the drilling direction.

Sensor system (910) can include one or more sensors for generating various sensor data. For example, sensor system (910) can include various sensors for monitoring fluid flow properties (e.g., fluid flow rate and/or pressure). The sensor data, generated by these sensors, can allow the BHA (110) to detected modulated fluid flow. For instance, these can include fluid flow sensors, pressure transducers, or sensors that can monitor the rotation rate of a motor (e.g., turbine), driven by changing flow rate. The sensors for monitoring the rotation rate include (but are not limited to), magnetometers, accelerometers, and inertial gyroscopes.

More generally, sensor subsystem (910) can also include various types of monitoring sensors. Monitoring sensors can include sensors for monitoring directional properties and/or formation properties.

Directional sensors include sensors that monitor the inclination and/or azimuth of the BHA (110). In some examples, these include inertial measurement units (IMUs), or one or more accelerometer or gyroscopes, which can enable gravity steering. They may also include magnetometers, which can enable magnetic steering. Directional sensors can generate data that allows measuring the trajectory of the assembly, as the wellbore as being drilled.

Sensor system (910) can also include other sensors for measuring wellbore properties, including rock formation density, temperature, porosity and/or annular and bore pressure. These can also

Other sensors included in the sensor system (910) can include sensors for monitoring rotational speed of the drilling string (108), type and severity of vibration, torque and weigh on bit.

In some examples, the sensor systems (10) comprise a measurement-while-drilling (MWD) system for real-time data collection, and communication to an above-surface unit, e.g., control system (114). In other cases, the sensor system (10) includes a logging-while-drilling (LWD) system.

Reference is now made to FIG. 9B, which shows a simplified block diagram for an example hardware architecture for control system (114) (FIG. 1).

As shown, the control system (114) generally includes a processor (950) coupled, via a computer data bus, to one or more of a memory (952), an I/O interface(s) (954), a signal detector (956), a display interface (958) and an input interface (960).

I/O interface(s) (954) can couple to control the pump system (112). For example, this can allow control system (114) can control the pump strokes to modulate the flow properties, as previously discussed. I/O interface(s) (954) can also couple to the flow diverter (120). This can also allow the control system (114) to control the diverter valves with a view to modulating flow properties.

Signal detector (956) is used to receive and decode signals transmitted by the bottom-hole assembly (BHA) (110). For example, this can include various uplinked sensor data, acquired by the BHA (110), such as directional sensor data. The uplink data can be received via any suitable technique, including fluid-pulse telemetry or electromagnetic (EM) telemetry.

In some examples, the control system (114) can also include a display interface (958) (e.g., LCD screen or the like) for displaying uplinked data, received by the signal detector.

Input interface (960) is any interface for receiving inputs, e.g., from an operator user. This can include a keyboard and/or mouse, or a touchscreen interface (e.g., a capacitive touchscreen interface). In some cases, where the input interface (960) is a touchscreen interface, the input interface and display interface are one of the same.

### XI. INTERPRETATION

Various systems or methods will be described below to provide an example of an embodiment of the claimed subject matter. No embodiment described below limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described below is not an embodiment that is recited in any claimed subject matter. Any subject matter disclosed in a system or method described below that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device. As used herein, two or more components are said to be “coupled”, or “connected” where the parts are joined or operate together either directly or indirectly (i.e., through one or more intermediate components), so long as a link occurs. As used herein and in the claims, two or more parts are said to be “directly coupled”, or “directly connected”, where the parts are joined or operate together without intervening intermediate components.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a pushbutton keyboard, mouse, a touchscreen, and the like), and at least one output device (e.g. a display screen, a printer, a wireless radio, and the like) depending on the nature of the device.

It should also be noted that there may be some elements that are used to implement at least part of one of the embodiments described herein that may be implemented via software that is written in a high-level computer programming language such as object oriented programming or script-based programming. Accordingly, the program code may be written in Java, Swift/Objective-C, C, C++, Javascript, Python, SQL or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. The computer program product may also be distributed in an over-the-air or wireless manner, using a wireless data connection.

The term “software application” or “application” refers to computer-executable instructions, particularly computer-executable instructions stored in a non-transitory medium, such as a non-volatile memory, and executed by a computer processor. The computer processor, when executing the instructions, may receive inputs and transmit outputs to any of a variety of input or output devices to which it is coupled. Software applications may include mobile applications or “apps” for use on mobile devices such as smartphones and tablets or other “smart” devices.

A software application can be, for example, a monolithic software application, built in-house by the organization and possibly running on custom hardware; a set of interconnected modular subsystems running on similar or diverse hardware; a software-as-a-service application operated remotely by a third party; third party software running on outsourced infrastructure, etc. In some cases, a software application also may be less formal, or constructed in ad hoc fashion, such as a programmable spreadsheet document that has been modified to perform computations for the organization's needs.

Software applications may be deployed to and installed on a computing device on which it is to operate. Depending on the nature of the operating system and/or platform of the computing device, an application may be deployed directly to the computing device, and/or the application may be downloaded from an application marketplace. For example, user of the user device may download the application through an app store such as the Apple App Store™ or Google™ Play™.

Still further yet, the inventors have appreciated that there are no existing effective tools which can, in addition to automatically determining appropriate weight-based bolus dosage, can also automatically prepare the bolus dose, i.e., automatically prepare a syringe or IV bag. If present, such tools would have significance in eliminating, or reducing, errors in the bolus preparation process.

The present invention has been described here by way of example only, while numerous specific details are set forth herein in order to provide a thorough understanding of the exemplary embodiments described herein. However, it will be understood by those of ordinary skill in the art that these embodiments may, in some cases, be practiced without these specific details. In other instances, well-known methods, procedures and components have not been described in detail so as not to obscure the description of the embodiments. Various modification and variations may be made to these exemplary embodiments without departing from the spirit and scope of the invention, which is limited only by the appended claims.

1. A system for downlink communication with a bottom-hole assembly (BHA), comprising:
a control system comprising at least one processor configured for:
identifying a command ratio value (CRV) associated with at least one command;
based on the CRV, determining a command time (CT) and a command divisor time (CDT) for encoding the at least one command into a command signal;
transmitting the command signal by controlling modulation of drilling fluid flow properties and generating a modulated fluid flow,
wherein the modulated fluid flow: (i) extends for a duration of time equal to the CT, and (ii) varies between at least a base flow state and a modified flow state, the modified flow state extending for the command divisor time (CDT); and
the bottom-hole assembly (BHA) comprising at least one controller configured for:
detecting the modulated fluid flow corresponding to the command signal;
analyzing the modulated fluid flow to determine the command time (CT) and the command divisor time (CDT);
determining the CRV based on the analyzed CT and DT; and
decoding the at least one command based on the CRV.

2. The system of claim 1, wherein the at least one controller of the BHA is further configured for operating the assembly to execute the at least one command.

3. The system of claim 1, wherein the at least one command relates to one or more of: adjusting a tool operating mode, selecting a steering reference field, and adjusting a steering target.

4. (canceled)

5. (canceled)

6. The system of claim 1, wherein determining the CRV by the at least one processor, of the control system, comprises accessing pre-defined assignment data comprising associations between commands and corresponding CRVs, wherein the assignment data comprises associations between commands and command identifiers, the command identifiers being generated from the CRV.

7. (canceled)

8. (canceled)

9. (canceled)

10. The system of claim 1, wherein the drilling system further comprises at least one pump for pumping drilling fluid to the BHA, and controlling modulation of fluid properties comprises controlling the at least one pump.

11. The system of claim 1, wherein the drilling system further comprises at least one flow diverter, and controlling modulation of fluid properties comprises controlling the at least one flow diverter.

12. (canceled)

13. (canceled)

14. The system of claim 1, wherein the modulated fluid flow varies between three flow states corresponding to: (i) the base flow state; (ii) an intermediate flow state; and (iii) the modified flow state.

15. (canceled)

16. The system of claim 1, wherein modulating the fluid flow properties to transmit the command signal comprises controlling modulation of the fluid flow properties to:
initially, generate a trigger signature portion;
subsequently, generate a modified flow portion wherein the fluid properties are maintained at the modified flow state for the command divisor time (CDT); and
generate a return flow portion, wherein the fluid flow properties are returned to the base flow state.

17. The system of claim 16, when depending from claim 14, wherein the trigger signature portion comprises: (a) a first transition from the base state to the intermediate state; (b) a plateau at the intermediate state; and (c) a second transition from the plateau to the modified state.

18. The system of claim 1, wherein the CRV is related to the command time (CT) and command divisor time (CDT) as expressed by the equation:
$$Command Ratio Value ( CRV ) = CT / CDT \times CT$$

19. (canceled)

20. The system of claim 1, wherein after transmitting the command signal, the at least one processor, of the control system, is further configured for:
transmitting a data payload signal, associated with the command signal, by further controlling modulation of the drilling fluid flow properties.

21. (canceled)

22. The system of claim 16, wherein the at least one controller of the BHA detects the modulated fluid flow, corresponding to the command signal, by detecting the trigger signature, and detecting the trigger signature comprises comparing the modulated fluid flow configuration to an expected configuration for the trigger signature.

23. (canceled)

24. The system of claim 1, wherein the BHA further comprises a sensor system coupled to the at least one controller, and detecting the modulated fluid flow is based on sensor data generated by the sensor system.

25. (canceled)

26. The system of claim 1, wherein analyzing the modulated fluid flow, by the at least one controller of the BHA, to determine the command time (CT) and command divisor time (CDT) comprises:
determining the command time (CT) based on determining a start time and end time for the CT; and
determining the command divisor time (CDT) based on determining a start time and end time for the CDT.

27. The system of claim 2, wherein the at least one controller of the BHA is further configured for:
subsequent to detecting a first modulated fluid flow corresponding to the command signal, detecting a second modulated fluid flow corresponding to a data payload signal; and
operating the assembly to execute the at least one command and command parameters decoded from the data payload signal.

28. The system of claim 27, wherein the data payload signal is received within a data gate time interval of the command signal.

29. (canceled)

30. (canceled)

31. The system of claim 6, wherein the at least one processor, of the control system, is further configured for:
determining transmission properties of different commands;
identifying one or more downlink optimization criteria; and
updating the assignment data based on the transmission properties and the downlink optimization criteria.

32. The system of claim 6, wherein the at least one processor, of the control system, is further configured for:
determining an operation mode;
selecting an assignment dataset, of one or more assignment datasets, association with the operation mode; and
transmitting command signals using the selected assignment dataset.

33. (canceled)

34. (canceled)

35. A method for downlink communication comprising:
identifying, by at least one processor of a control system, a command ratio value (CRV) associated with at least one command;
based on the CRV, determining, by the at least one processor, a command time (CT) and a command divisor time (CDT) for encoding the at least one command into a command signal;
transmitting, by the at least one processor, the command signal by controlling modulation of drilling fluid flow properties and generating a modulated fluid flow,
wherein the modulated fluid flow: (i) extends for a duration of time equal to the CT, and (ii) varies between at least a base flow state and a modified flow state, the modified flow state extending for the command divisor time (CDT).

36. (canceled)

37. A method for downlink communication comprising:
detecting, by at least one controller of the bottom-hole assembly (BHA), a modulated fluid flow corresponding to the command signal,
wherein the modulated fluid flow: (i) extends for a duration of time equal to a command time (CT), and (ii) varies between at least a base flow state and a modified flow state, the modified flow state extending for a command divisor time (CDT); and;
analyzing, by the at least one controller, the modulated fluid flow to determine a command time (CT) and the command divisor time (CDT);
determining, by the at least one controller, a command ratio value (CRV) based on the analyzed CT and CDT; and
decoding, by at least one controller, for at least one command based on the CRV.
